(19) United States
(12) Patent Application Publication
(10) Pub. No.: US 2009/0158390 A1
(43) Pub. Date: Jun. 18, 2009

(54) METHOD, SYSTEM AND APPARATUS FOR AUTHENTICATION

(76) Inventor: Hongguang Guan, Shenzhen (CN)

Correspondence Address: BRINKS HOFER GILSON & LIONE, P.O. BOX 10395, CHICAGO, IL, 60610, US

(21) Appl. No.: 12/388,692

(22) Filed: Feb. 19, 2009

Related U.S. Application Data
(63) Continuation of application No. PCT/CN2007/070539, filed on Aug. 23, 2007.

(30) Foreign Application Priority Data
Aug. 31, 2006 (CN) 200610111873.5

(51) Int. Cl. H04L 9/00; H04L 29/06

(52) U.S. Cl. 726/2

(57) ABSTRACT

An authentication method disclosed herein includes a requester sending an authentication request to an authenticator, the authenticator returning a response message which carries a source MAC address and a destination MAC address, the requester comparing the source MAC address between at least two authenticators and selecting an authenticator as a specified authenticator according to the set address selection rule to perform authentication with the requester. Further, the present disclosure discloses an authentication system. The present disclosure supports 802.1x authentication in a scenario with one requester and multiple authenticators. The disclosure also discloses a requester and an authenticator.

### CROSS REFERENCES TO RELATED APPLICATIONS

This application is a continuation of International Application No. PCT/CN2007/070539 filed on Aug. 23, 2007 which claims priority to Chinese Patent Application No. 200610111873.5, filed with the Chinese Patent Office on Aug. 31, 2006 and entitled “Method and System for Authentication” both of which are incorporated herein by reference in their entirety.

### FIELD OF THE DISCLOSURE

This disclosure relates to the field of Internet technologies, and in particular, to a method, system, and apparatus for performing 802.1x authentication.

### BACKGROUND

With the development of Internet technologies, network security becomes more and more important. Service providers (SPs) expects to control the user access, which gives rise to Institute for Electrical and Electronic Engineering (IEEE) 802.1x protocol, commonly known as 802.1x protocol. The 802.1x is a port-based network access control protocol which was enacted by the IEEE standardization organization in December 2004.

The port-based network access control performs authentication and control for the access client on the physical access level of the network switch, namely, network access device. The physical access level refers to a port of the network access device such as Ethernet switch or broadband access switch. The user connected to the port can access the resources in the network if the user passes the authentication successfully and is unable to access the resources in the network if the authentication fails. In the port-based network access control protocol defined by the 802.1x protocol, the port may be a physical port or a logical port. There are two typical application modes: a physical port of the Ethernet switch is connected with a client computer or the Wireless Local Area Network (WLAN) access mode defined by the IEEE802.1x protocol.

The application system of the 802.1x protocol involves a requester, an authenticator, and an authentication server. The requester refers to a client, and the client of the 802.1x is generally installed in a Personal Computer (PC). On the user access layer, the Ethernet switch implements the functions of an 802.1x authenticator. The Authentication Authorization Accounting (AAA) server based on 802.1x generally resides in the AAA center of the operator. An Extended Authentication Protocol (EAP) over LAN (EAPoL) defined by IEEE 802.1x runs between the 802.1x client and the Ethernet switch, and an EAP runs between the Ethernet switch and the AAA server.

The 802.1x authentication process is described below.

After a physical connection is created between the requester and the authenticator, the requester sends a start message such as “EAPoL-Start” to a multicast address “01-80-C2-00-00-03”, indicating the start of 802.1x access.

The authenticator sends a message of requesting authentication such as “EAP-Request/Identity” to the requester address, requiring the requester to report his/her username to the authenticator.

The requester replies with a message (such as EAP-Response/Identity) carrying a username to the authenticator in response to the message of requesting authentication.

The authenticator sends an access request message such as Access-Request to the Radius AAA server. The access request message is in the format of EAP Over Radius (Remote Authentication Dial in User Service) and carries the EAP-Response/Identity message sent by the requester to the authenticator, thus submitting the username to the Radius AAA server.

The Radius AAA server generates a challenge word composed of 128 bits.

The Radius AAA server replies to the authenticator with an access challenge word message such as “Access-Challenge” which carries an EAP-Request/MD5-Challenge message. Further, the EAP-Request/MD5-Challenge message carries a Challenge word generated by the Radius AAA server.

The authenticator sends an EAP-Request/MD5-Challenge message to the requester, thus sending the Challenge word to the requester.

After receiving the EAP-Request/MD5-Challenge message, the requester lets the password and the Challenge word undergo the Message-Digest Algorithm 5 (MD5) and sends the obtained Challenge-Password to the authenticator through an EAP-Response/MD5-Challenge.

The authenticator sends a Challenge-Password to the Radius AAA server through an Access-Request message, and the Radius AAA server authenticates the password.

The Radius AAA server judges whether the user is legal according to the user information which contains Challenge-Password and a username. The Radius AAA server replies with an authentication success/failure message to authenticator. If the authentication succeeds, the message carries negotiation parameters and the relevant service attributes of the user to the requester for the purpose of authentication.

According to the authentication result, the authenticator replies to the requester with an authentication success/failure message (such as “EAP-Success/EAP-Failure”) notifying the requester of the authentication result. If the authentication fails, the process is ended. If the authentication succeeds, authorization and charging are performed subsequently.

It is evident that the foregoing 802.1x authentication process is suitable to the scenario with one requester and one authenticator and does not cover the scenario with multiple requesters.

In view of the foregoing problems, the prior art provides a method for performing 802.1x authentication in the case that one authenticator and multiple requesters exist in shared media. A shared medium may be a device like a hub. For example, parties connected through a hub can receive messages sent by a party.

In this method, the authenticator is connected with multiple requesters through a shared medium. In this case, the authenticator creates a virtual sub-interface on the interface connected with the shared medium according to a Media Access Control (MAC) address or an IP address of each requester so that each virtual sub-interface corresponds to a requester. The authenticator records the rights of each virtual sub-interface. For example, the sub-interfaces that are allowed to access a Virtual Private Network (VPN), the sub-interfaces that are allowed to access the Internet, and the ones that are recorded on the AAA server. The rights of the virtual sub-interfaces are set by an AAA server and recorded by the authenticator accordingly. When a requester sends an authentication requester, the authenticator executes the authentication process according to the virtual sub-interface corresponding to each requester.

This method in the prior art executes 802.1x authentication in the case that one authenticator and multiple requesters exist in a shared medium but disregards how to authenticate in a scenario with one requester and multiple authenticators. In the practical network, it is possible that one requester and multiple authenticators exist. Therefore, a method is required to implement 802.1x authentication in a scenario with one requester and multiple authenticators.

### SUMMARY

The present disclosure provides a method, system, and apparatus for authentication. The method and system support 802.1x authentication in a scenario with one requester and multiple authenticators.

The technical solution under the present disclosure includes an authentication method that includes s ending, by a requester, an authentication request returning, by an authenticator that receives the authentication request, a response message carrying a source Media Access Control (MAC) address and a destination MAC address, wherein at least two authenticators receive the authentication request, and comparing the source MAC address between at least two authenticators, selecting an authenticator as a specified authenticator among at least two authenticators according to a set address selection rule, and performing authentication with the requester.

The technical solution under the present disclosure further includes an authentication system that includes a requester and at least two authenticators wherein the requester is adapted to send an authentication request, receive a response message carrying a source MAC address and a destination MAC address from each authenticator, compare the source MAC address of the authenticators, select an authenticator as a specified authenticator according to the set address selection rule, and perform authentication with the specified authenticator. The authenticator is adapted to return a response message carrying a source MAC address and a destination MAC address to the requester after receiving an authentication request. The specified authenticator performs authentication interaction with the requester. The destination MAC address is the requester address. Or, alternatively, the requester is adapted to send an authentication request, receive a response message carrying a source MAC address and a destination MAC address from each authenticator, and perform authentication with the specified authenticator among at least two authenticators. The authenticator is adapted to return a response message carrying a source MAC address and a destination MAC address to the requester after receiving an authentication request, compare the source MAC address of the authenticators, select an authenticator as a specified authenticator according to the set address selection rule, and perform authentication interaction with the requester. The destination MAC address is a multicast address.

The technical solution according to the present disclosure further includes a requester, including an authentication interaction unit adapted to send an authentication request, receive a response message carrying a source MAC address and a destination MAC address from each authenticator, and perform authentication with the specified authenticator and an authenticator selecting unit adapted to compare the source MAC address of the authenticators where the destination MAC address is the requester address and select an authenticator as a specified authenticator according to the set address selection rule.

The technical solution according to the present disclosure further includes an authenticator that includes an authentication interaction unit adapted to return a response message carrying a source MAC address and a destination MAC address to the requester after receiving an authentication request. where the destination MAC address is a multicast address, and the authentication interaction unit performs authentication interaction with the requester when the authenticator is a specified authenticator, an authenticator selecting unit adapted to compare the source MAC address of the authenticators and select an authenticator as a specified authenticator according to the set address selection rule, a monitoring unit adapted to monitor the authentication process between the authenticator and the requester when the authenticator is a non-specified authenticator, and an authorizing unit adapted to receive an authentication success message carrying requester information from the specified authenticator and assign rights to the requester.

It can be seen from the foregoing technical solution that:

When the present disclosure applied in a scenario with one requester and multiple authenticators, the requester sends an authentication request to the authenticator, and the authenticator returns a response package carrying a source MAC address and a destination MAC address. By comparing the source MAC address between at least two authenticators, according to the set selection rule, the system selects a specified authenticator among multiple authenticators, and the specified authenticator performs authentication with the requester, thus enabling authentication in a scenario with one requester and multiple authenticators.

### BRIEF DESCRIPTION OF THE DRAWINGS

FIG. 1 is an overall flowchart of the method according to the present disclosure;

FIG. 2 is a flowchart according to a first embodiment of the present disclosure;

FIG. 3 is a flowchart according to a second embodiment of the present disclosure; and

FIG. 4 is a schematic diagram of the system according to the present disclosure.

### DETAILED DESCRIPTION

An authentication method provided in the present disclosure is to compare the source MAC address of at least two authenticators in the process of 802.1x authentication in a shared medium in the case that one requester and multiple authenticators exist and select a specified authenticator for performing authentication with the requester according to the set address selection rule.

The present disclosure is hereinafter described in detail with reference to embodiments and accompanying drawings.

It is assumed that requester A accesses a network through a shared medium, and authenticators B and C access the network concurrently. When requester A sends the first EAPoL-Start message to the shared medium, authenticators B and C reply with an EAP-Request/Identity message requiring requester A to report the username. In this case, requester A receives two EAP-Request/Identity packets and is unable to identify the true authenticator. This embodiment of the present disclosure aims to solve such a problem.

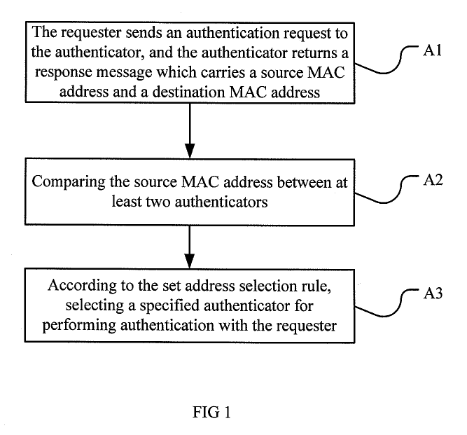

As shown in FIG. 1, an overall flowchart of the method according to the present disclosure includes the steps detailed hereinafter.

A1. The requester sends an authentication request to the authenticator, and the authenticator returns a response message which carries a source MAC address and a destination MAC address.

A2. Comparing the source MAC address between at least two authenticators.

A MAC address is an identifier for identifying a network node and is unique globally. Therefore, the source MAC address of each authenticator is fixed.

A3. According to the set address selection rule, selecting a specified authenticator for performing authentication with the requester.

The set address selection rule is to select the authenticator with the greater MAC address or the smaller one as a specified authenticator.

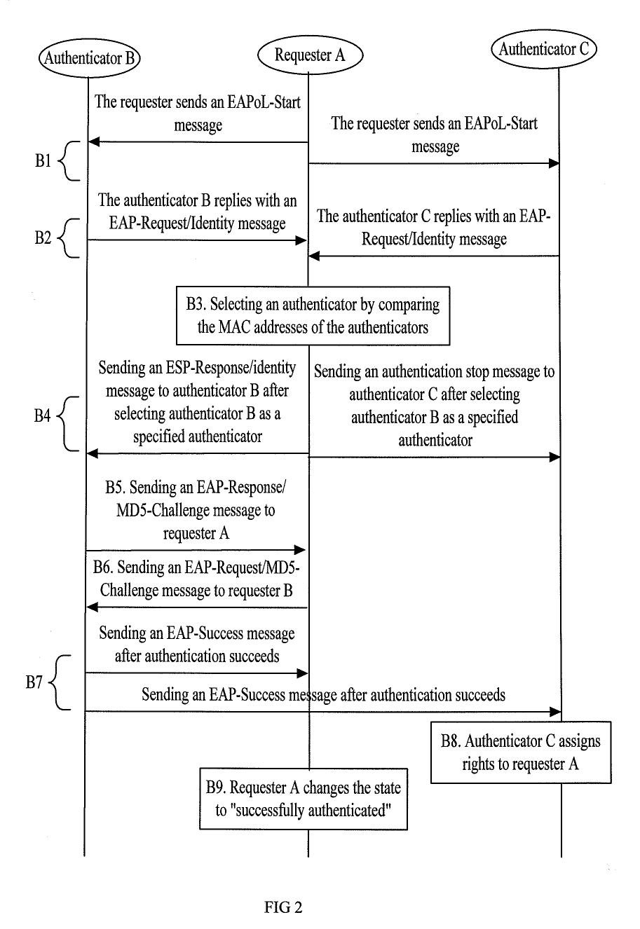

As shown in FIG. 2, the process according to the first embodiment of the present disclosure includes steps detailed hereinafter.

B1. Requester A sends an EAPoL-Start into the shared media, and authenticators B and C receive the EAPoL-Start message from requester A concurrently.

It should be noted that, before step B1, a connection is created between authenticator B and authenticator C, and authenticators B and C are mutually trusted.

B2. Authenticators B and C reply with an EAP-Request/Identity message requiring requester A to report the username.

The message returned by authenticators B and C carries a source MAC address and a destination MAC address in which the destination MAC address is the address of requester A.

B3. After receiving two EAP-Request/Identity messages, requester A retrieves the source MAC addresses from the two messages, compares the source MAC addresses, selects the authenticator with the greater source MAC address or the smaller one as a specified authenticator according to the set rule (for example, selects authenticator B as a specified authenticator), and proceeds with the subsequent 802.1x authentication process.

B4. Requester A replies to authenticator B with an EAP-Response/Identity which carries a username and sends an EAP-Failure message to authenticator C to notify authenticator C to stop 802.1x authentication.

B5. Through an EAP-Request/MD5-Challenge, authenticator B sends a Challenge generated by the AAA server to requester A.

B6. After receiving the EAP-Request/MD5-Challenge message, requester A lets the password and the Challenge word undergo the Message-Digest Algorithm 5 (MD5) to obtain a Challenge-Password and sends the obtained Challenge-Password to authenticator B through an EAP-Response/MD5-Challenge.

B7. Authenticator B sends the received information to the AAA server for authenticating. If the authentication fails, authenticator B sends an EAP-Failure message to requester A, and the authentication process is ended. If the authentication process succeeds, authenticator B sends an EAP-Success message whose destination MAC address is the multicast address “01-80-C2-00-00-03”.

It should be noted that, in the authentication process in the prior art, the destination MAC address of the EAP-Success message is requester A. In this embodiment of the present disclosure, the destination MAC address changes to the multicast address “01-80-C2-00-00-03” because the multicast address is designed for use in 802.1x and more essentially, authenticator C also needs to assign relevant rights to requester A after the authentication between requester A and authenticator B succeeds. However, as authenticator C does not take part in the authentication between requester A and authenticator B, authenticator B needs to send an authentication message whose destination MAC address is the multicast address so that authenticator C can receive the message and enable the corresponding port to assign proper rights to requester A when the authentication succeeds. Moreover, authenticator C needs to add a field into the EAP-Success message. The field is the address of requester A and indicates which requester in the shared media is authenticated successfully. In the prior art, the successfully authenticated requester is indicated through the destination MAC address.

B8. After receiving an EAP-Success message whose destination MAC address is 01-80-C2-00-00-03, authenticator C retrieves the details of the message, enables the corresponding port, and assigns proper rights to requester A.

B9. After receiving an EAP-Success message whose destination MAC address is 01-80-C2-00-00-03, authenticator A modifies its 802.1x state machine so that the state of authenticator A changes from unauthenticated to successfully authenticated.

The process of the first embodiment described above is summarized as: requester A selects either authenticator B or authenticator C as a specified authenticator.

Alternatively, the EAP-Request/Identity message may be modified at the beginning so that the specified authenticator is selected among the two authenticators. When requester A sends the first EAPoL-Start message to the shared medium, authenticators B and C reply with an EAP-Request/Identity message. In the traditional 802.1x protocol, the destination MAC address of the EAP-Request/Identity is the MAC address of requester A. As a result, although authenticator B and authenticator C receive messages from other each, they find that the destination MAC address of the message is not their own address and hence discard the message. If the destination MAC address of the EAP-Request/Identity message is modified to the multicast address “01-80-C2-00-00-03”, authenticators B and C analyze the EAP-Request/Identity message received from the opposite party, retrieve the source MAC address of the opposite party for comparing with their own source MAC address, and check who is the authenticator of the shared medium.

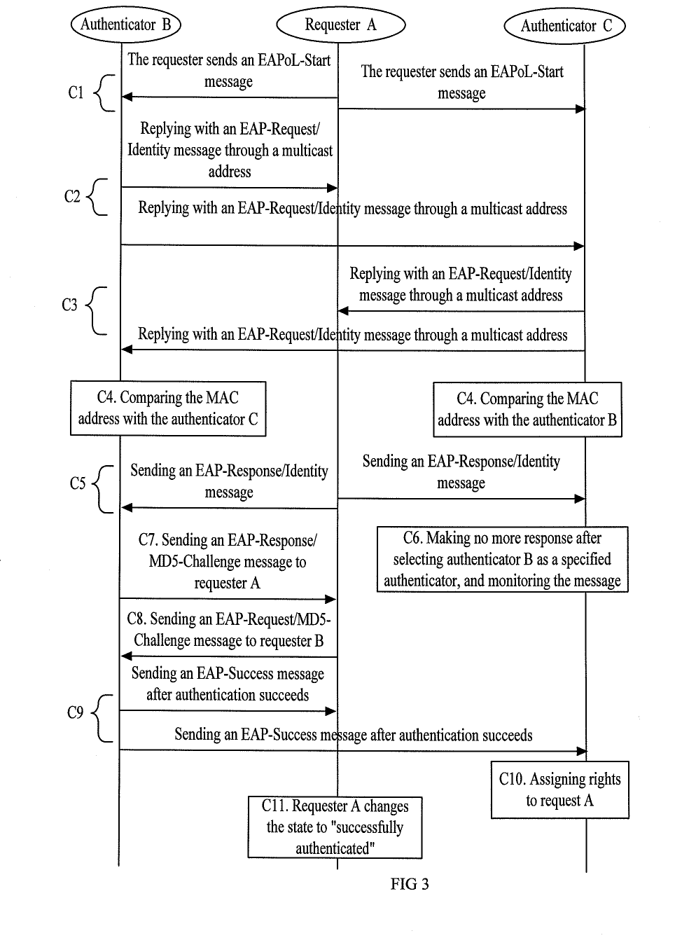

The process of the second embodiment shown in FIG. 3 varies with the first embodiment of the present disclosure in that a specified authenticator is selected out of multiple authenticators by the authenticators, including the steps detailed hereinafter.

C1. Requester A sends an EAPoL-Start into the shared media, and authenticators B and C receive the EAPoL-Start message from requester A concurrently.

It should be noted that before step B1, a connection is created between authenticator B and authenticator C, and authenticators B and C are mutually trusted.

C2. Authenticator B replies with an EAP-Request/identity message, requiring requester A to report the username.

The message returned by authenticator B carries a source MAC address and a destination MAC address. It should be noted that the destination MAC address of the EAP-Request/Identity message here is the multicast address “01-80-C2-00-00-03” so that both requester A and authenticator C receive the EAP-Request/Identity message sent by authenticator B.

C3. Authenticator C replies with an EAP-Request/Identity message, requiring requester A to report the username.

The message returned by authenticator C carries a source MAC address and a destination MAC address. It should be noted that the destination MAC address of the EAP-Request/Identity message here is the multicast address “01-80-C2-00-00-03” so that both requester A and authenticator B receive the EAP-Request/Identity message sent by authenticator C.

Step C2 may occur either before or after step C3.

C4. After receiving an EAP-Request/Identity message from authenticator C, authenticator B analyzes the EAP-Request/Identity message of authenticator C and retrieves the source MAC address of authenticator C for comparing with its own source MAC address. Depending on the set rule, authenticator B selects the authenticator with the greater source MAC address or the smaller one as a specified authenticator of the shared media.

Likewise, after receiving an EAP-Request/Identity message from authenticator B, authenticator C compares the source MAC address as mentioned above. Because the source MAC addresses of authenticators B and C are fixed and the rule of selecting the authenticator with the greater source MAC address or smaller one is fixed, it is certain that the authenticator selected by authenticator B is the same as the one selected by authenticator C for the shared medium. For example, authenticator B is ultimately selected as a specified authenticator.

C5. Requester A replies to authenticators B and C with an EAP-Response/Identity which carries a username.

C6. Authenticator C monitors the 802.1x authentication process of authenticators A and B and no longer responds to the EAP-Response/Identity message from requester A.

After an authenticator selects a certain authenticator as a specified authenticator of the shared medium, no further 802.1x authentication message will be sent any more. In this case, authenticator C only monitors the 802.1x authentication between requester A and the selected authenticator. After selecting authenticator B as a specified authenticator, authenticator C monitors the 802.1x authentication process between requester A and authenticator B.

C7. Through an EAP-Request/MD5-Challenge, authenticator B sends a Challenge generated by the AAA server to requester A.

After being selected as a specified authenticator, the authenticator performs the responsibilities as a specified authenticator and works together with requester A to perform subsequent steps of 802.1x authentication. Here, the specified authenticator is authenticator B.

C8. After receiving the EAP-Request/MD5-Challenge message, requester A allows the password and the Challenge word to undergo the Message-Digest Algorithm 5 (MD5) to obtain a Challenge-Password and sends the obtained Challenge-Password to authenticator B through an EAP-Response/MD5-Challenge.

C9. Authenticator B sends the received information to the AAA server for authenticating. If the authentication fails, authenticator B sends an EAP-Failure message to requester A, and the authentication process is ended. If the authentication process succeeds, authenticator B sends an EAP-Success message whose destination MAC address is the multicast address “01-80-C2-00-00-03”.

When authenticator B sends an EAP-Success message whose destination MAC address is the multicast address “01-80-C2-00-00-03”, both requester A and authenticator C receive the EAP-Success message.

C10. After receiving an EAP-Success message whose destination MAC address is 01-80-C2-00-00-03, authenticator C retrieves the details of the message for analyzing and discovers that requester A has been authenticated by authenticator B successfully and hence enables the port connected with the shared medium to assign proper rights to requester A.

C11. After receiving an EAP-Success message whose destination MAC address is 01-80-C2-00-00-03, authenticator A modifies its 802.1x state machine so that the state of authenticator A changes from unauthenticated to successfully authenticated.

It should be noted that the foregoing embodiment supposes that two authenticators—authenticators B and C exist. In the practical application, more authenticators may exist. For example, three authenticators—authenticators B, C and D may exist. In this example, authenticator B trusts authenticator C, and authenticator C trusts authenticator D. If authenticator D is selected as a specified authenticator and authenticates requester A successfully, namely, trusts requester A, authenticators B and C trust requester A and assign proper rights to requester A.

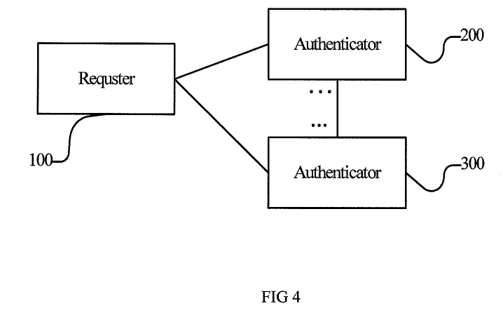

Introduced above is an authentication method according to the present disclosure. Accordingly, the present disclosure provides an authentication system. FIG. 4 is a schematic diagram of the system according to the present disclosure.

The system includes a requester 100 and multiple authenticators—authenticator 200, and authenticator 300, as illustrated in the figure. The authenticators trust each other. It should be noted that the authentication performed by this system is 802.1x authentication performed in a shared medium.

The requester 100 is adapted to send authentication requests to the authenticator and select a specified authenticator among multiple authenticators.

The authenticators 200 and 300 are adapted to return a response message carrying a source MAC address and a destination MAC address to the requester 100 after the requester 100 sends an authentication request and select a specified authenticator among multiple authenticators.

In this system, the requester 100 compares the source MAC address between authenticators (for example, authenticators 200 and 300) and selects a specified authenticator according to the set address selection rule in order to perform authentication. Before comparison, the destination MAC address in the response message returned by authenticators 200 and 300 to the requester 100 is the address of the requester 100.

Alternatively, in this system, both the authenticator 200 and the authenticator 300 compare the source MAC address between authenticators and select a specified authenticator according to the set address selection rule in order to perform authentication. Before comparison, the destination MAC address in the response message returned by authenticators 200 and 300 to the requester 100 is a multicast address. It should be noted that here the destination MAC address of the EAP-Request/Identity message returned by authenticators 200 and 300 to the requester 100 is a multicast address “01-80-C2-00-00-03”. Therefore, both the requester 100 and the authenticator 300 receive the EAP-Request/Identity message sent by authenticator 200. Likewise, both the requester 100 and the authenticator 200 receive the EAP-Request/Identity message sent by the authenticator 300.

The requester 100, the authenticator 200, and the authenticator 300 select a specified authenticator according to the following rule:

selecting the authenticator with the greater source MAC address or the smaller one as a specified authenticator. When authenticators 200 and 300 select a specified authenticator, it is certain that the authenticator selected by the authenticator 200 is the same as the one selected by the authenticator 300 for the shared medium because the source MAC addresses of authenticators 200 and 300 are fixed and the rule for selecting the authenticator with the greater source MAC address or the smaller one is fixed.

After the authenticators 200 and 300 select a specified authenticator, other authenticators monitor the authentication process between the specified authenticator and the requester 100. For example, if the specified authenticator is authenticator 200, the authenticator 300 monitors the authentication process between the specified authenticator 200 and the requester 100. Likewise, if the specified authenticator is authenticator 300, the authenticator 200 monitors the authentication process between the authenticator 300 and the requester 100.

After authenticating the requester 100 successfully, the specified authenticator sends an EAP-Success message to the requester 100. The destination MAC address of the message is multicast address “01-80-C2-00-00-03”, and the message carries the information indicative of the requester. Other authenticators assign rights to the requester 100 according to the received message. If the requester 100 is authenticated unsuccessfully, the specified authenticator sends an EAP-Failure message to the requester 100.

Further, a requester disclosed in an embodiment of the present disclosure includes an authentication interaction unit and an authenticator selecting unit wherein the authentication interaction unit is adapted to send an authentication request, receive a response message carrying a source MAC address and a destination MAC address from each authenticator, and perform authentication with the specified authenticator. The authenticator selecting unit is adapted to compare the source MAC address between the authenticators, where the destination MAC address is the requester address, and select an authenticator as a specified authenticator according to the set address selection rule.

The foregoing address selection rule is to select the authenticator with the greater source MAC address or the smaller one as a specified authenticator.

Further, an authenticator disclosed in an embodiment of the present disclosure includes an authentication interaction unit, an authenticator selecting unit, a monitoring unit, and an authorizing unit, wherein the authentication interaction unit is adapted to return a response message carrying a source MAC address and a destination MAC address to the requester after receiving an authentication request where the destination MAC address is a multicast address. The authentication interaction unit performs authentication interaction with the requester when the authenticator is a specified authenticator. The authenticator selecting unit is adapted to compare the source MAC address between the authenticators and select an authenticator as a specified authenticator according to the set address selection rule. The monitoring unit is adapted to monitor the authentication process between the authenticator and the requester when the authenticator is a non-specified authenticator and the authorizing unit is adapted to receive an authentication success message carrying requester information from the specified authenticator and assign rights to the requester.

The foregoing address selection rule is to select the authenticator with the greater source MAC address or the smaller one as a specified authenticator.

Detailed above are an authentication method and an authentication system under the present disclosure. Although the disclosure is described through some exemplary embodiments, the disclosure is not limited to such embodiments. It is apparent that those skilled in the art can make various modifications and variations to the disclosure without departing from the spirit and scope of the disclosure. The disclosure shall cover the modifications and variations provided that they fall in the scope of protection defined by the following claims or their equivalents.

What is claimed is:

1. An authentication method, comprising:
sending, by a requester, an authentication request;
receiving the authentication request by at least two authenticators;
returning, from the at least two authenticators that receive the authentication request, a respective response message each carrying a source Media Access Control (MAC) address and a destination MAC address; and
comparing the source MAC address of the at least two authenticators, selecting a specified authenticator among the at least two authenticators according to a set address selection rule, and performing authentication with the requester.

2. The authentication method of claim 1, wherein:
the set address selection rule is to select, as the specified authenticator, one of the at least two authenticators having one of a greater source MAC address or a smaller MAC address.

3. The authentication method of claim 1, wherein:
the destination MAC address carried in each response message returned by the at least two authenticators is a requester address and comparison is performed by the requester.

4. The authentication method of claim 1, wherein:
the destination MAC address carried in each response message returned by the at least two authenticators is a multicast address and the comparison is performed by the authenticator.

5. The authentication method of claim 4, further comprising:
monitoring the authentication between the specified authenticator and the requester by a non-specified authenticator that receives the authentication request.

6. The authentication method according to claim 1, wherein the destination MAC address of each message is a multicast address, and each message carries information indicative of the requester, the authentication method further comprising:
after the requester is authenticated successfully, sending, by the specified authenticator, an authentication success message to the requester; and
assigning, by the specified authenticator, rights to the requester according to the received authentication success message.

7. The authentication method of claim 1, wherein:
the authentication is 802.1x authentication.

8. A requester, comprising:
an authentication interaction unit adapted to send an authentication request, receive a response message carrying a source Media Access Control (MAC) address and a destination MAC address from each authenticator that receives the authentication request, and perform authentication with a specified authenticator; and
an authenticator selecting unit adapted to compare the respective source MAC address of the authenticators, wherein each destination MAC address is a requester address and select one of the authenticators as a specified authenticator according to a set address selection rule.

9. The requester of claim 8, wherein:
the address selection rule is to select, as the specified authenticator, one of the authenticators having a greater source MAC address or a smaller MAC address.

10. An authenticator, comprising:
an authentication interaction unit adapted to return a response message carrying a source Media Access Control (MAC) address and a destination MAC address to a requester after receiving an authentication request, where the destination MAC address is a multicast address and the authentication interaction unit performs authentication interaction with the requester when the authenticator is a specified authenticator;
an authenticator selecting unit adapted to compare the source MAC address of authenticators and select a specified authenticator among the authenticators according to a set address selection rule;
a monitoring unit adapted to monitor authentication between one of the authenticators and the requester when the one of the authenticators is a non-specified authenticator; and
an authorizing unit adapted to receive an authentication success message carrying requester information from the specified authenticator and assign rights to the requester.

11. The authenticator of claim 10, wherein:
the address selection rule is to select, as the specified authenticator, the authenticator with a greater source MAC address or a smaller MAC address.
